(19) United States
(12) Patent Application Publication
(10) Pub. No.: US 2023/0224124 A1
(43) Pub. Date: Jul. 13, 2023

(54) ENHANCED GUARD PERIOD BETWEEN SRS RESOURCES

(71) Applicant: Telefonaktiebolaget LM Ericsson (publ), Stockholm (SE)

(72) Inventors: Andreas Nilsson, Göteborg (SE); Sven Jacobsson, Västra Frölunda (SE); Robert Mark Harrison, Grapevine, TX (US); Eleftherios Karipidis, Stockholm (SE)

(21) Appl. No.: 18/023,750

(22) PCT Filed: Aug. 31, 2021
(86) PCT No.: PCT/IB2021/057963

§ 371 Date: Feb. 28, 2023

Related U.S. Application Data
(60) Provisional application No. 63/072,772, filed on Aug. 31, 2020.

(51) Int. Cl. H04L 5/00

(52) U.S. Cl. CPC H04L 5/0051; H04L 5/0007; H04L 5/0094

(57) ABSTRACT

Systems and methods are disclosed herein that relate to an enhanced guard period between Sounding Reference Signal (SRS) resources. In one embodiment, a method performed by a wireless communication device comprises receiving a SRS configuration from a radio access node, wherein the SRS configuration defines SRS resources in compliance with a predefined or preconfigured minimum guard period between adjacent SRS resources in different slots. The method further comprises transmitting SRSs in accordance with the SRS configuration. In this manner, improved SRS guard period specification is provided, which leads to a better trade-off between SRS signal quality and SRS resource utilization.

### RELATED APPLICATIONS

This application claims the benefit of provisional patent application serial No. 63/072,772, filed Aug. 31, 2020, the disclosure of which is hereby incorporated herein by reference in its entirety.

### TECHNICAL FIELD

The present disclosure relates to Sounding Reference Signal (SRS) configuration in a cellular communications system.

### BACKGROUND

The SRS is used in Third Generation Partnership Project (3GPP) Long Term Evolution (LTE) and New Radio (NR) systems to provide Channel State Information (CSI) in the uplink (UL). The application for the SRS is mainly to provide a reference signal to evaluate the channel quality in order to, e.g., derive the appropriate transmission/reception beams or to perform link adaptation (i.e., setting the rank, the Modulation and Coding Scheme (MCS), and the Multiple-Input Multiple-Output (MIMO) precoder) for Physical Downlink Shared Channel (PDSCH) and Physical Uplink Shared Channel (PUSCH) transmission.

In LTE and NR, the SRS is configured via Radio Resource Control (RRC), and some parts of the configuration can be updated, for reduced latency, by Medium Access Control (MAC) Control Element (CE) signaling. The configuration includes the SRS resource allocation as well as the time behavior (aperiodic, semi-persistent or periodic).

### SRS Configuration

The SRS configuration allows generating an SRS transmission pattern based on an SRS resource configuration grouped into SRS resource sets. Each SRS resource is configured with the SRS-Resource Information Element (IE) in RRC (see 3GPP 38.331 version 16.1.0).

To create the SRS resource on the time-frequency grid with the current RRC configuration, each SRS resource is thus configurable with respect to:
The number of transmission combs (i.e., mapping to every n^{th} subcarrier, where n=2 or n=4), configured by the RRC parameter transmissionComb. The combs may be constructed in the time domain by forming a number of repetitions of the SRS sequence and multiplying the k^{th} repeated sequence by exp (jπkn_{c}/n), where n, corresponds to the comb offset below.
   For each SRS resource, a comb offset, configured by the RRC parameter combOffset, is specified (i.e., which of the n combs to use).
   A cyclic shift, configured by the RRC parameter cyclicShift, that maps the SRS sequence to the assigned comb, is also specified. The cyclic shift increases the number of SRS resources that can be mapped to a comb, but there is a limit on the number of cyclic shifts that can be used that depends on the transmission comb being used.
The time-domain position of an SRS resource within a given slot is configured with the RRC parameter resourceMapping.
   A time-domain start position for the SRS resource, which is limited to be one of the last 6 symbols in a slot, is configured by the RRC parameter startPosition.
   A number of Orthogonal Frequency-Division Multiplexing (OFDM) symbols for the SRS resource (that can be set to 1, 2 or 4) is configured by the RRC parameter nrofSymbo/s.
   A repetition factor (that can be set to 1, 2 or 4) configured by the RRC parameter repetitionFactor. When this parameter is larger than 1, the same frequency resources are used multiple times across OFDM symbols, used to improve the coverage as more energy is collected by the receiver. It can also be used for beam-management functionality, where the gNodeB (gNB) can probe different receive beams for each repetition.
The frequency-domain sounding bandwidth and position of an SRS resource in a given OFDM symbol (i.e., which part of the system bandwidth is occupied by the SRS resource) is configured with the RRC parameters freqDomainPosition, freqDomainShiftand the freqHopping parameters: c-SRS, b-SRS, and b-hop. The smallest possible sounding bandwidth in a given OFDM symbol is 4 resource blocks (RBs).

A schematic description of how an SRS resource is allocated in time and frequency in a given OFDM symbol within a slot (if resourceMapping-r16 is not signaled) is provided in FIG. 1. Note that c-SRS controls the maximum sounding bandwidth, which can be smaller than the maximum transmission bandwidth the User Equipment (UE) supports. For example, the UE may have capability to transmit over 40 MHz bandwidth, but c-SRS is set to a smaller value corresponding to 5 MHz, thereby focusing the available transmit power to a narrowband transmission which improves the SRS coverage.

In NR release 16, an additional RRC parameter called resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and repetition factor is still limited to 4) can start in any of the 14 OFDM symbols (see FIG. 2) within a slot, configured by the RRC parameter startPosition-r16.

The RRC parameter resourceType configures whether the resource is transmitted as periodic, aperiodic (single transmission triggered by Downlink Control Information (DCI)), or semi persistent (same as periodic but the start and stop of the periodic transmission is controlled by MAC CE signaling instead of RRC signaling). The RRC parameter sequenceIdspecifies how the SRS sequence is initialized, and the RRC parameter spatialRelationInfo configures the spatial relation for the SRS beam with respect to a reference signal (RS) which can be either another SRS, Synchronization Signal Block (SSB), or CSI Reference Signal (CSI-RS). Hence, if the SRS has a spatial relation to another SRS, then this SRS should be transmitted with the same beam (i.e., spatial transmit filter) as the indicated SRS.

The SRS resource is configured as part of an SRS resource set. Within an SRS resource set, the following parameters (common to all SRS resources in the SRS resource set) may be configured in RRC:
The associated CSI-RS resource (this configuration is only applicable for non-codebook-based UL transmission) for each of the possible resource types (aperiodic, periodic, and semi-persistent). For aperiodic SRS, the associated CSI-RS resource is set by the RRC parameter csi-RS For periodic and semi-persistent SRS, the associated CSI-RS resource is set by the RRC parameter associatedCSI-RS Note that all resources in a resource set must share the same resource type.
For aperiodic resources, the slot offset is configured by the RRC parameter slotOffset and sets the delay from the Physical Downlink Control Channel (PDCCH) trigger reception to start of the transmission of the SRS resources measured in slots.
The resource usage, which is configured by the RRC parameter usage sets the constraints and assumption on the resource properties (see 3GPP 38.214).
The power-control RRC parameters alpha, p0, pathlossReferenceRS (indicating the downlink reference signal (RS) that can be used for path-loss estimation), srs-PowerControlAdjustmentStates, and pathlossReferenceRSList-r16 (for NR release 16), which are used for determining the SRS transmit power.

Each SRS resource set is configured using the SRS-ResourceSet IE in RRC (see 3GPP 38.331 version 16.1.0).

Hence it can be seen that in terms of resource allocation, the SRS resource set configures usage (SRS resource sets can be configured with four different usages: ‘beamManagement’, ‘codebook’, ‘nonCodebook’, or ‘antennaSwitching’), power control, aperiodic transmission timing, and downlink (DL) resource association. The SRS resource configuration controls the time-and-frequency allocation, the periodicity and offset of each resource, the sequence ID for each resource, and the spatial-relation information.

Guard Period for Antenna Switching

SRS resources in an SRS resource set configured with usage ‘antennaSwitching’ are used to sound the channel in the UL so that the gNB can use reciprocity to determine suitable DL precoders. If the UE has the same number of transmit and receive chains, the UE is expected to transmit one SRS port per UE antenna. The mapping from SRS ports to antenna ports is, however, up to the UE to decide and is transparent to the gNB.

For SRS with usage set to ‘antennaSwitching’, a minimum guard period is configured between the SRS resources within a slot to account for transmit-antenna switching transient time. For reference, the exact text in 3GPP TS 38.214 reads: “The UE is configured with a guard period of Y symbols, in which the UE does not transmit any other signal, in the case the SRS resources of a set are transmitted in the same slot. The guard period is in-between the SRS resources of the set.” In 3GPP TS 38.214 Table 6.2.1.2-1, (see FIG. 5), the minimum number of OFDM symbols used as guard period between two SRS resources belonging to the same SRS resource set and which are in the same slot is defined. As shown in the table, the minimum guard period is 1 OFDM symbol for the case when the subcarrier spacing (SCS) is smaller than 120 kHz and 2 OFDM symbols for the case when the SCS is 120 kHz, as schematically illustrated in FIG. 6 and FIG. 7 for a UE with one 1 transmit port and 2 receive ports without SRS repetition and/or SRS frequency hopping. Here, SRS resource #1 is used to sound the first SRS port, and SRS resource #2 is used to sound the second SRS port.

For adjacent transmission of Physical Uplink Control Channel (PUCCH) or PUSCH and SRS, a time mask is specified instead of a guard period (see Section 6.3.3 of 3GPP 38.101-1 V16.4.0 and Section 6.3.3 of 3GPP 38.101-2 V16.4.0 for the time mask for frequency range 1 (FR1) and Frequency Range 2 (FR2), respectively). As illustrated in FIG. 8 (from 3GPP 38.101-1), the purpose of the time mask is to introduce a relaxed transmission requirement for a short period between adjacent transmissions of SRS and PUCCH/PUSCH. For FR1, the time mask is valid for 10 μs before and after the SRS transmission for the case when the same UE-antenna port is being used for both SRS and PUCCH/PUSCH and 15 μs for the case when SRS and PUSCH/PUCCH are transmitted on different UE-antenna ports. For the duration of this time mask, normal UE radio frequency (RF) requirements do not apply, which implies that the UE can transmit PUCCH/PUSCH directly before/after an SRS transmission but with some expected degradation in signal quality. For FR2 there is a 5 μs time mask between PUCCH/PUSCH and SRS irrespectively of which antenna is being sounded, before and after the PUCCH/PUSCH transmission.

### SUMMARY

Systems and methods are disclosed herein that relate to an enhanced guard period between Sounding Reference Signal (SRS) resources. In one embodiment, a method performed by a wireless communication device comprises receiving a SRS configuration from a radio access node, wherein the SRS configuration defines SRS resources in compliance with a predefined or preconfigured minimum guard period between adjacent SRS resources in different slots. The method further comprises transmitting SRSs in accordance with the SRS configuration. In this manner, improved SRS guard period specification is provided, which leads to a better trade-off between SRS signal quality and SRS resource utilization.

In one embodiment, a wireless communication device comprises one or more transmitters, one or more receivers, and processing circuitry associated with the one or more transmitters and the one or more receivers. The processing circuitry is configured to cause the wireless communication device to receive a SRS configuration from a radio access node, wherein the SRS configuration defines SRS resources in compliance with a predefined or preconfigured minimum guard period between adjacent SRS resources in different slots. The processing circuitry is further configured to cause the wireless communication device to transmit SRSs in accordance with the SRS configuration.

In another embodiment, a method performed by a wireless communication device comprises receiving a SRS configuration from a radio access node, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) a number of combs used for SRS transmission, (d) subcarrier spacing, (e) capability of the wireless communication device to support flexible minimum guard periods for SRS, or (f) a combination of any two or more of (a)-(e). The method further comprises transmitting SRSs in accordance with the SRS configuration.

In one embodiment, a wireless communication device comprises one or more transmitters, one or more receivers, and processing circuitry associated with the one or more transmitters and the one or more receivers. The processing circuitry is configured to cause the wireless communication device to receive a SRS configuration from a radio access node, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) a number of combs used for SRS transmission, (d) subcarrier spacing, (e) capability of the wireless communication device to support flexible minimum guard periods for SRS, or (f) a combination of any two or more of (a)-(e). The processing circuitry is further configured to cause the wireless communication device to transmit SRSs in accordance with the SRS configuration.

Corresponding embodiments of a radio access node and a method of operation thereof are also disclosed. In one embodiment, a method performed by a radio access node comprises obtaining a SRS configuration for a wireless communication device, wherein the SRS configuration defines SRS resources in compliance with a predefined or preconfigured minimum guard period between adjacent SRS resources in different slots. The method further comprises transmitting or initiating transmission of the SRS configuration to the wireless communication device.

In one embodiment, a radio access node comprises processing circuitry configured to cause the radio access node to obtain a SRS configuration for a wireless communication device, wherein the SRS configuration defines SRS resources in compliance with a predefined or preconfigured minimum guard period between adjacent SRS resources in different slots. The processing circuitry is further configured to cause the radio access node to transmit or initiate transmission of the SRS configuration to the wireless communication device.

In another embodiment, a method performed by a radio access node comprises obtaining a SRS configuration for a wireless communication device, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) subcarrier spacing, (d) capability of the wireless communication device to support flexible minimum guard periods for SRS, or (e) a combination of any two or more of (a)-(d). The method further comprises transmitting or initiating transmission of the SRS configuration to the wireless communication device.

In one embodiment, a radio access node comprises processing circuitry configured to cause the radio access node to obtain a SRS configuration for a wireless communication device, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) subcarrier spacing, (d) capability of the wireless communication device to support flexible minimum guard periods for SRS, or (e) a combination of any two or more of (a)-(d). The processing circuitry is further configured to cause the radio access node to transmit or initiate transmission of the SRS configuration to the wireless communication device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates how an SRS is allocated in time and frequency in a given OFDM symbol within a slot in 3GPP when parameter resoruceMapping-r16 is not signaled;

FIG. 2 illustrates how an SRS is allocated in time and frequency in a given OFDM symbol within a slot in 3GPP when parameter resoruceMapping-rl6 is signaled;

FIG. 3 illustrates one example of SRS frequency hopping;

FIG. 4 illustrates one example of SRS repetition;

FIG. 5 is a reproduction of Table 6.2.1.2-1 from 3GPP Technical Specification (TS) 38.214;

FIGS. 6 and 7 illustrate that the minimum guard period is 1 OFDM symbol for the case when the SCS is smaller than 120 kilohertz (kHz) and 2 OFDM symbols for the case when the SCS is 120 kHz, for a UE with one 1 transmit port and 2 receive ports without SRS repetition and/or SRS frequency hopping;

FIG. 8 is a reproduction of FIGS. 6.3.3.7-1 and 6.3.3.7-2 from 3GPP TS 38.101-1;

FIG. 9 illustrates a problem associated with SRS configuration in existing 3GPP specifications wherein SRS resources from NR Release 16 and onwards can be transmitted in two adjacent OFDM symbols in two different slots;

FIG. 10 illustrates one example of a cellular communications system in which embodiments of the present disclosure may be implemented;

FIG. 11 illustrates that, with the new capability introduced in NR Release 16 in which SRS resources can be allocated in any of the 14 OFDM symbols of a slot, it is possible to configure SRS transmissions in two adjacent OFDM symbols, where the two adjacent OFDM symbols belong to two different slots;

FIG. 12 illustrates the operation of a radio access node and a UE in accordance with embodiments of the present disclosure;

FIG. 13 illustrates an example of antenna switching with repetition factor 4 for a UE with 1 transmit port and 2 receive ports;

FIG. 14 illustrates one example of how the UE with 1 transmit port and 2 receive ports can be configured if the need for a guard period is removed;

FIG. 15 illustrates one example of an embodiment in which a new minimum guard period table is introduced with the relaxed minimum guard time requirements, where the relaxed requirements of the minimum guard period depends on both the SCS and on the repetition factor;

FIGS. 16 and 17 illustrate one example of minimum guard period tables in accordance with an embodiment, one for UEs with fast antenna switching (FIG. 16) and one for UEs with slow antenna switching (FIG. 17), where the UE signals to the network an indication of which of the two tables is/are supported by the UE;

FIG. 18 illustrates the operation of a radio access node and a UE in accordance with embodiments of the present disclosure;

FIGS. 19, 20, and 21 are schematic block diagrams of example embodiments of a radio access node; and

FIGS. 22 and 23 are schematic block diagrams of example embodiments of a UE.

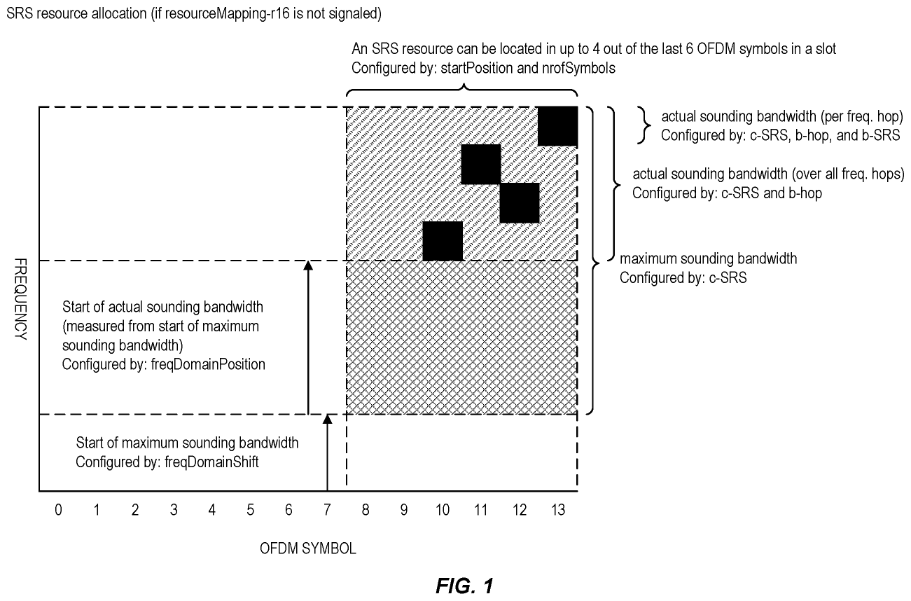

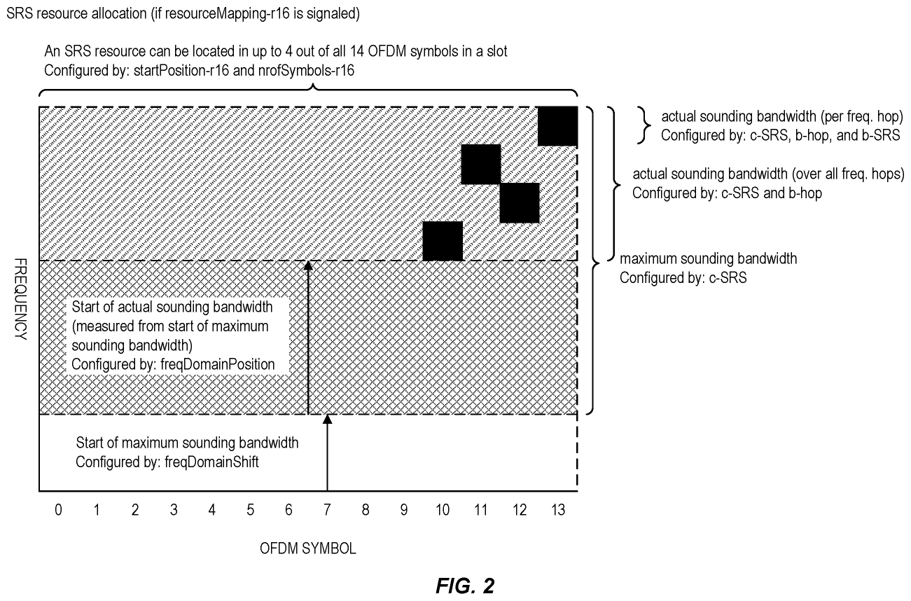

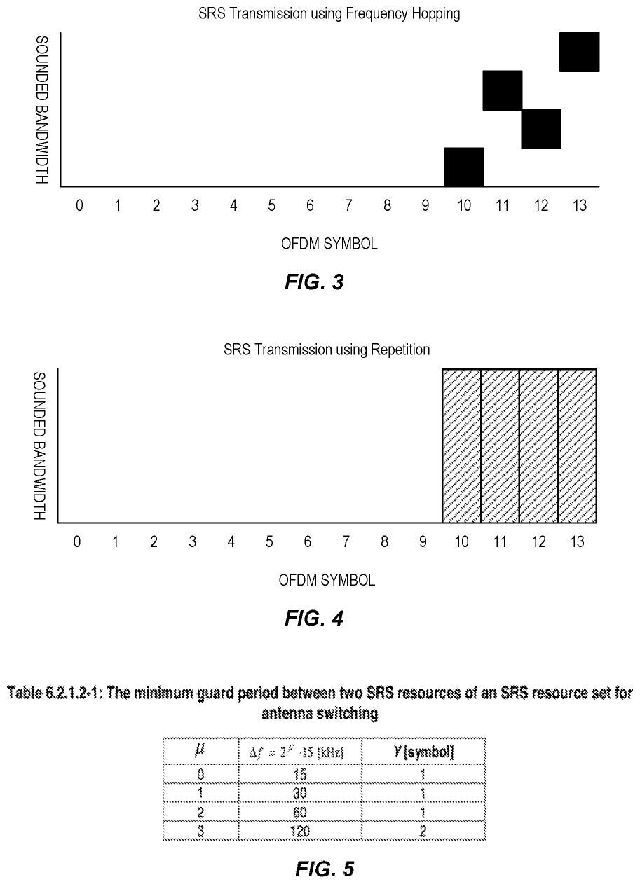

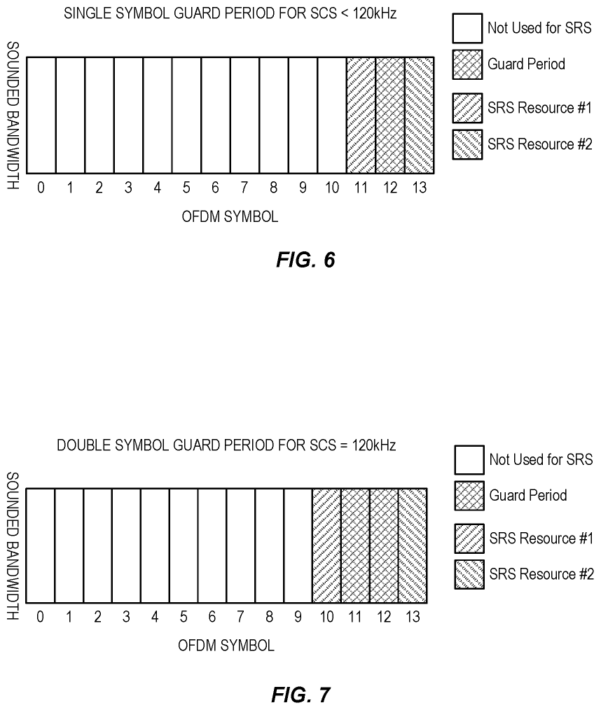

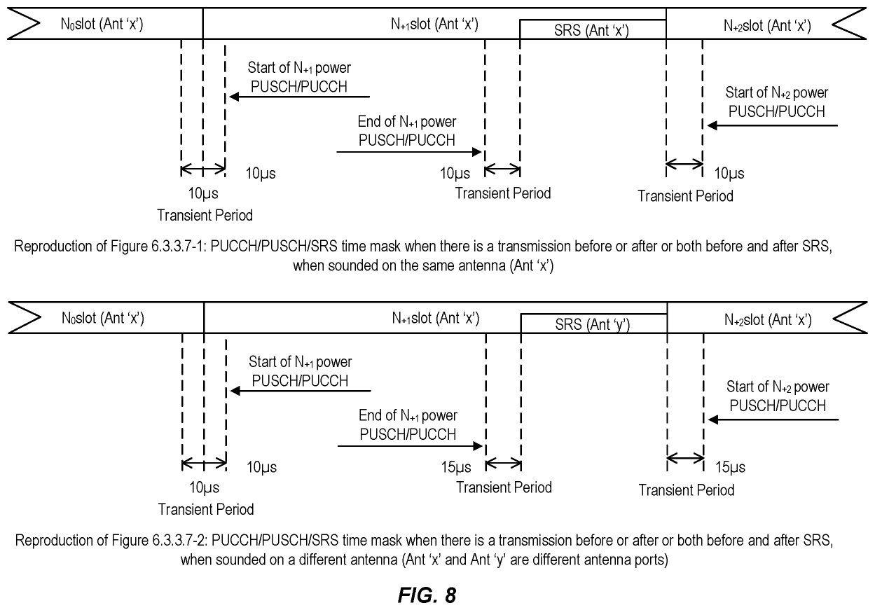

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a gNB in an 3GPP NR network or an enhanced or evolved Node B (eNB) in a 3GPP LTE network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a UE in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

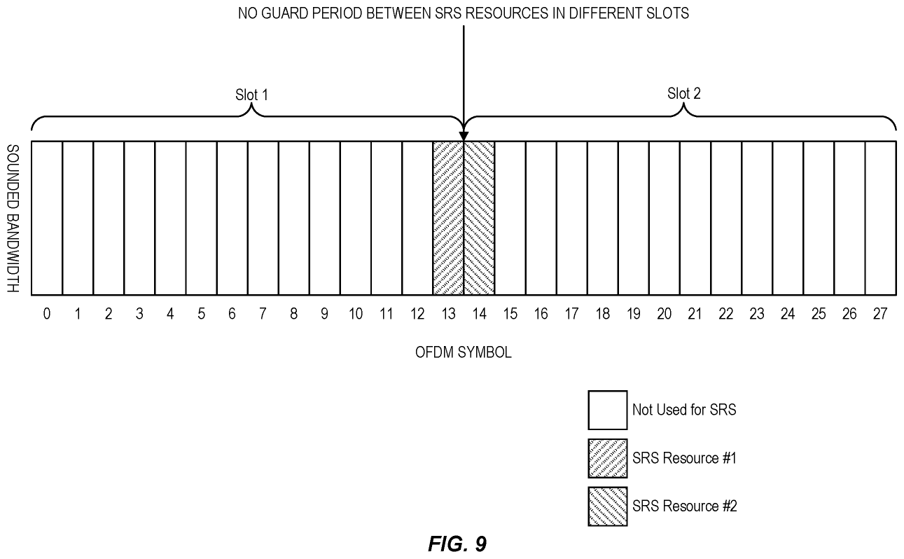

There currently exist certain challenge(s). In NR release 16, it has been agreed that a SRS resource can be configured to start in any of the 14 OFDM symbols within a slot, while, in NR release 15, only the last 6 OFDM symbols could be used. This means that SRS resources from NR release 16 and onwards can be transmitted in two adjacent OFDM symbols in two different slots, as schematically illustrated in FIG. 9. However, configuring two SRS resources in adjacent OFDM symbols may cause degraded signal quality of the SRS due to the transient time before/after an SRS transmission.

The minimum guard period ensures a reliable signal quality of transmitted UL signals at the cost of unused resources in that the OFDM symbols used as a guard period cannot be used for other transmissions. In some cases, for example when there is small SCS, i.e., when the OFDM symbol duration is long, or high-order repetition for each SRS resource, the reduced signal quality for an SRS resource due to the transient time associated with antenna switching might be less of a problem, and, hence, enforcing a guard period between SRS transmissions might be associated with higher costs than gains.

Certain aspects of the present disclosure and their embodiments may provide solutions to the aforementioned or other challenges. Systems and methods are disclosed herein for an enhanced guard time framework for SRS transmissions. In some embodiments, the enhanced guard time framework for SRS transmissions includes guard periods between slots. In some embodiments, the enhanced guard time framework for SRS transmissions additionally or alternatively includes flexible guard periods depending on SRS repetition factor, number of SRS combs, SCS, and/or UE capabilities.

Certain embodiments may provide one or more of the following technical advantage(s). Embodiments of the solutions disclosed herein may provide improved SRS guard period specification, which leads to a better trade-off between SRS signal quality and SRS resource utilization.

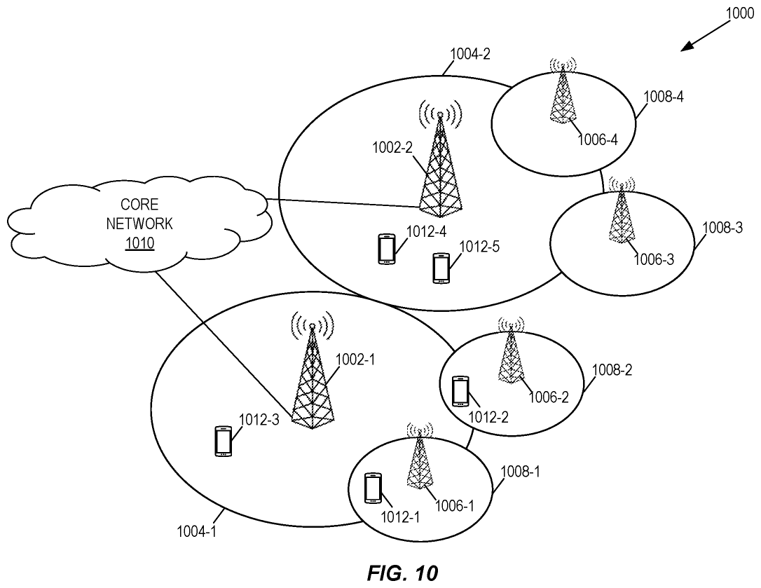

FIG. 10 illustrates one example of a cellular communications system 1000 in which embodiments of the present disclosure may be implemented. In the embodiments described herein, the cellular communications system 1000 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 1002-1 and 1002-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 1004-1 and 1004-2. The base stations 1002-1 and 1002-2 are generally referred to herein collectively as base stations 1002 and individually as base station 1002. Likewise, the (macro) cells 1004-1 and 1004-2 are generally referred to herein collectively as (macro) cells 1004 and individually as (macro) cell 1004. The RAN may also include a number of low power nodes 1006-1 through 1006-4 controlling corresponding small cells 1008-1 through 1008-4. The low power nodes 1006-1 through 1006-4 can be small base stations (such as pico or femto base stations) or Remote Radio Heads (RRHs), or the like. Notably, while not illustrated, one or more of the small cells 1008-1 through 1008-4 may alternatively be provided by the base stations 1002. The low power nodes 1006-1 through 1006-4 are generally referred to herein collectively as low power nodes 1006 and individually as low power node 1006. Likewise, the small cells 1008-1 through 1008-4 are generally referred to herein collectively as small cells 1008 and individually as small cell 1008. The cellular communications system 1000 also includes a core network 1010, which in the 5GS is referred to as the 5GC and in the EPS is referred to as the EPC. The base stations 1002 (and optionally the low power nodes 1006) are connected to the core network 1010.

The base stations 1002 and the low power nodes 1006 provide service to wireless communication devices 1012-1 through 1012-5 in the corresponding cells 1004 and 1008. The wireless communication devices 1012-1 through 1012-5 are generally referred to herein collectively as wireless communication devices 1012 and individually as wireless communication device 1012. In the following description, the wireless communication devices 1012 are oftentimes UEs, but the present disclosure is not limited thereto.

Now, a description of embodiments of the solutions disclosed herein will be provided. Note that while these embodiments are in some cases described separately, the following embodiments may be used separately or in any desired combination. Embodiment 1 (Guard Period between Adjacent OFDM Symbols in Two Different Slots)

In this embodiment, a guard period is defined between adjacent SRS resources in two different slots. In one embodiment, the current minimum guard period framework for an SRS resource set with usage ‘antennaSwitching’ is extended to also include a minimum guard period for transmission of SRS resources in adjacent slots. To highlight the need for this new guard period, consider the following example.

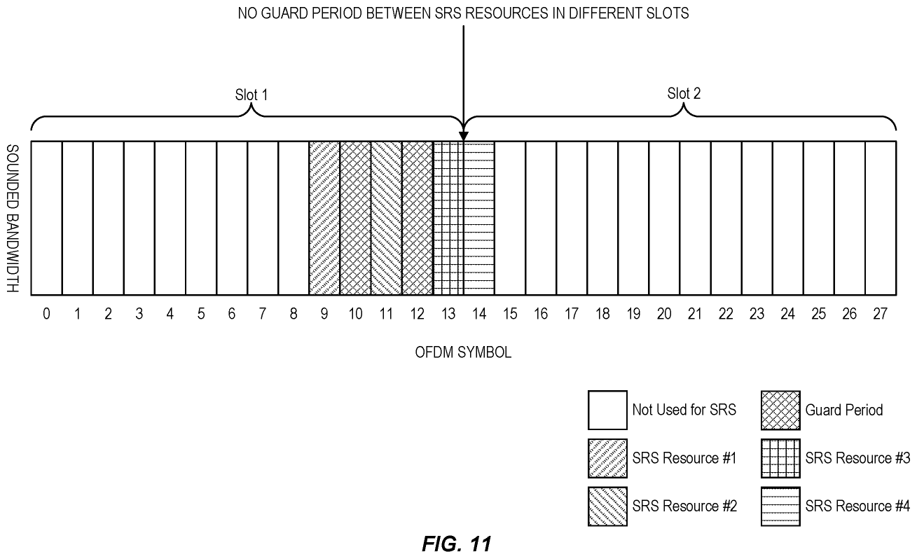

In current NR specifications, for aperiodic SRS transmission with usage ‘antennaSwitching’ and capability ‘1t4r’, two SRS resource sets with, in total, 4 single-port SRS resources are triggered, where at least one SRS resource is allocated in each SRS resource set. With the new capability introduced in NR release 16 in which SRS resources can be allocated in any of the 14 OFDM symbols of a slot, it is possible to configure SRS transmissions in two adjacent OFDM symbols, where the two adjacent OFDM symbols belong to two different slots, as schematically illustrated in FIG. 11. As discussed above, this could result in a degradation of the signal quality due to the transmit-antenna switching time.

Furthermore, in NR release 17, it is likely that more UE antenna-switching capabilities will be standardized (for example ‘1t6r’ and ‘1t8r’). For these cases, in some scenarios, depending on, e.g., SCS, SRS repetition factor, etc., SRS transmissions will need to be scheduled over more than one slot and, hence, it is again possible to schedule SRS transmissions in two adjacent OFDM symbols across a slot boundary (cf. FIG. 11), which results in a degradation of the signal quality due to the transmit-antenna switching time.

In one embodiment, this problem is solved by specifying a minimum guard period between SRS resources with usage ‘antennaSwitching’ also for the case when the concerned SRS resources belong to different slots.

In one example extension of this embodiment, a minimum guard period is introduced also for SRS extension resources that belong to one or more SRS resource sets with usage not necessarily set to ‘antennaSwitching’. For example, a minimum guard period can be specified between one SRS resource in a first slot that belongs to an SRS resource set with usage ‘codebook’ and an SRS resource in a second slot that belongs to an SRS resource set with usage ‘beamManagement’.

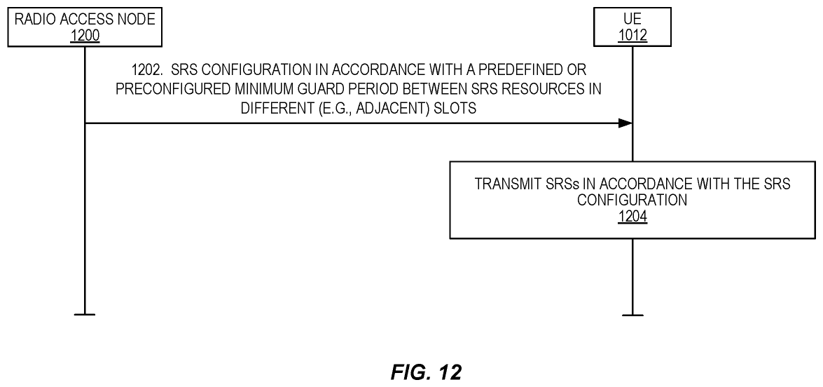

FIG. 12 illustrates the operation of a radio access node 1200 and a UE 1012 in accordance with at least some aspects of the embodiments described above. The radio access node 1200 may be a base station 1002 or a node that implements part of the functionality of the base station 1002 (e.g., a gNB-CU). As illustrated, the radio access node 1200 transmits or initiates transmission of an SRS configuration to the UE 1012 (step 1202). The SRS configurations includes a predefined or preconfigured minimum guard period between SRS resources in different (e.g., adjacent) slots. In other words, the SRS configuration defines SRS resources in compliance with a predefined or preconfigured minimum guard period between different (e.g., adjacent) SRS resources in different slots. In one embodiment, the predefined or preconfigured minimum guard period between adjacent SRS resources in different slots is defined in terms of a number of OFDM symbols.

In one embodiment, the SRS configuration includes a configuration of a first SRS resource set comprising one or more SRS resources in a first slot and a configuration of a second SRS resource set comprising one or more SRS resources in a second slot that immediately follows the first slot. In one embodiment, the SRS configuration further defines an amount of time between a first SRS resource in the first SRS resource set and a second SRS resource in the second SRS resource set that is adjacent to (in time) the first SRS resource in the first SRS resource set, wherein the amount of time is greater than the predefined or preconfigured minimum guard period between adjacent SRS resources in different slots. In one embodiment, the first SRS resource in the first SRS resource set is a last, in time, SRS resource from among the one or more SRS resources comprised in the first SRS resource set, and the second SRS resource in the second SRS resource set is a first, in time, SRS resource from among the one or more SRS resources comprised in the second SRS resource set. In one embodiment, both the first and second SRS resource sets are configured for antenna switching. The SRS configuration is such that an amount of time (e.g., number of OFDM symbols) between adjacent SRS resources in the first and second slots is greater than or equal to a predefined minimum guard period for SRS resources in different or adjacent slots. In other words, the SRS configuration is such that an amount of time (e.g., number of OFDM symbols) between a first SRS resource from the first SRS resource set in the first slot and a second SRS resource from the second SRS resource set in the second slot is greater than or equal to a defined minimum guard period for adjacent SRS resources in different slots. Here, the first SRS resource is the last (in time) SRS resource from among the SRS resource(s) in the first SRS resource set, and the second SRS resource is the first (in time) SRS resource from among the SRS resource(s) in the second SRS resource set.

Note that, as described below in the description of Embodiment 2, the predefined guard period between SRS resources (in different slots) is, in some embodiments, a flexible minimum guard period. More specifically, in one example, the predefined or preconfigured minimum guard period between SRS resources (in different slots) is a function of whether repetitions are used for SRS transmission (e.g., the repetition factor), number of SRS combs, SCS, and/or capabilities of the UE, as described below.

The UE 1012 receives the SRS configuration and transmits SRSs in accordance with the SRS configuration (step 1204).

### Embodiment 2 (Relaxed Guard Period)

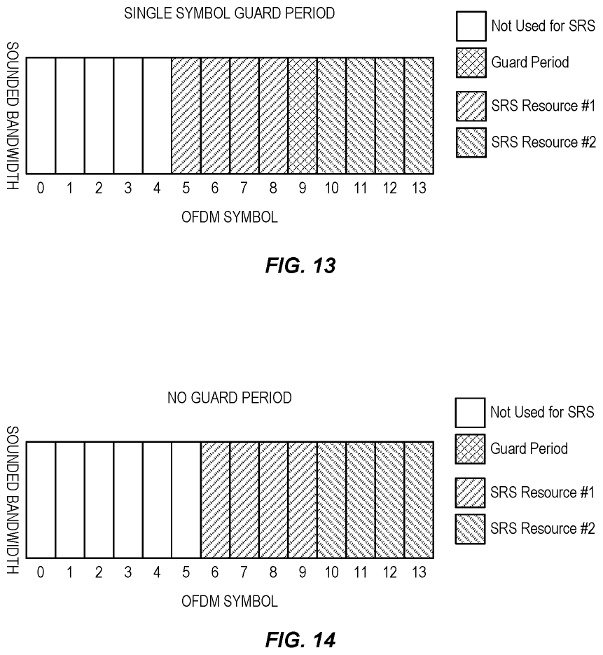

In NR release 15, repetition of an SRS resource was included in the specification to improve the signal-to-noise ratio (SNR) of the received SRS. Currently, an SRS resource can have a repetition factor of 1, 2, or 4, meaning that the same SRS resource is transmitted in 1, 2, or 4 adjacent OFDM symbols. An example of antenna switching with repetition factor 4 for a UE with 1 transmit port and 2 receive ports is illustrated in FIG. 13. As described above, there must be a guard period between SRS resources for antenna switching to ensure a reliable signal quality of the SRS resource. However, in case an SRS transmission is repeated (e.g., 4 times), the total signal-quality reduction due to the transient antenna-switching time might be less pronounced compared to the case of no repetition. Hence, in this case, it might be beneficial to remove the guard period to make better use of the available time-frequency resources (i.e., to find a better use for the OFDM symbol(s) that would otherwise have been unused in order to ensure that the guard period is fulfilled). FIG. 14 illustrates one example of how the UE with 1 transmit port and 2 receive ports can be configured if the need for a guard period is removed. As can be seen when comparing FIG. 13 and FIG. 14, one less OFDM symbol is used for the case in FIG. 14, which then can be used for other transmissions.

Thus, in one embodiment, the required minimum guard time is a function of whether repetitions are used for SRS transmission and, as an example, a function of the repetition factor used for SRS transmission.

In one embodiment, the required minimum guard period additionally or alternatively depends on the SCS, since a smaller SCS results in a longer duration of an OFDM symbol duration. The longer the duration of an OFDM symbol, the smaller the effect of the transient time will be (assuming that the transient time is the same irrespectively of the SCS), since the transient time will affect a smaller part of the OFDM symbol.

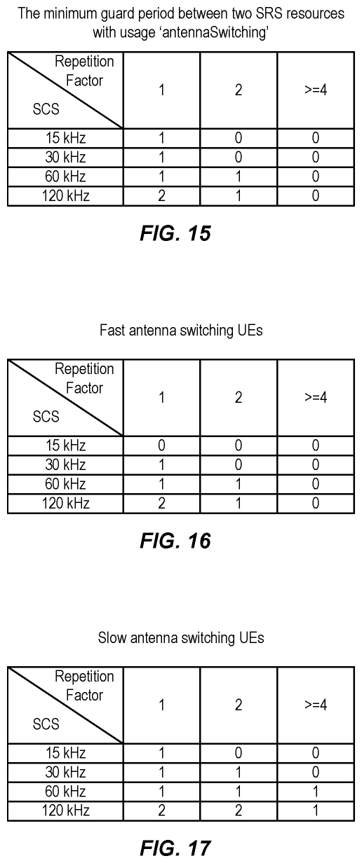

In one embodiment, the required minimum guard period is a function of both the repetition factor used for SRS transmission and the SCS. As one example of this embodiment, a new minimum guard period table is introduced with the relaxed minimum guard time requirements, as exemplified by FIG. 15, where the relaxed requirements of the minimum guard period depends on both the SCS and on the repetition factor. Note that this is just one example and that the table could, for example, depend only on the repetition factor or depend on both the repetition factor and the SCS (as depicted in FIG. 15).

In one embodiment, the required minimum guard period additionally or alternatively depends on the number of combs used to transmit SRS. If 2 combs are used, then there are two repetitions of the SRS sequence, and if the UE switches at the beginning and end of a symbol containing SRS transmission, each repetition of the SRS is distorted by the switching. On the other hand, if there are more than two combs, for example, then there are at more than two repetitions of the SRS sequence within a symbol, and there will be a repetition in between the first and last repetitions that is not affected by the switching. The gNB may then drop the SRS affected by switching, using only the SRS unaffected by the switching in its SRS reception, thereby avoiding distortion from switching.

Thus, in one embodiment, the required minimum guard time is a function of the number of combs used for SRS transmission. The minimum guard period is reduced when the UE transmits SRS with more than two combs compared to the minimum guard period with two combs. In some embodiments, the minimum guard period may be zero symbols long when more than two combs are used.

In one embodiment, there is some UE capability signaled from the UE to the gNB to inform the gNB if the UE supports the new relaxed minimum guard period for SRS antenna switching or not. Thus, in one example, the required minimum guard period is a function of UE capabilities. Further, in one example, the required minimum guard period is a function of UE capabilities and one or more of a repetition factor used for SRS transmission, a number of combs used for SRS transmission, and SCS.

In another example of this embodiment, a number of different minimum guard period tables with different guard periods are predefined (e.g., in 3GPP standards) or preconfigured. The UE signals to the gNB an indication of which minimum guard period table(s) from among those predefined or preconfigured tables are supported by the UE. This indication may be signaled from the UE to the gNB during, for example, the UE-capability signaling. The gNB then configures the UE with one of the supported tables. FIGS. 16 and 17 illustrate one example of two such minimum guard period tables, one for UEs with fast antenna switching (FIG. 16) and one for UEs with slow antenna switching (FIG. 17). Which table a UE supports could, for example, depend on how quickly the power amplifiers (PAs) at the UEs are able to ramp up the output power. The UE would signal to the gNB which of the two tables it supports. In some cases, the UE may indicate only one of the tables. However, in other cases, the UE may support both tables and therefore indicate, to the gNB, that it supports both tables. The gNB then selects one of the tables to use for the UE in accordance with the indication from the UE. The selected table is then used to determine the minimum guard period between two SRS resources of an SRS resource set. For example, the gNB generates the SRS configurations for the UE such that at least the minimum guard period exists between adjacent SRS resources in an SRS resource set. Note that while this example focuses on the minimum guard period between SRS resources in the same SRS resource set (for antenna switching), the same is true for the minimum guard period between adjacent SRS resources in different SRS resource sets.

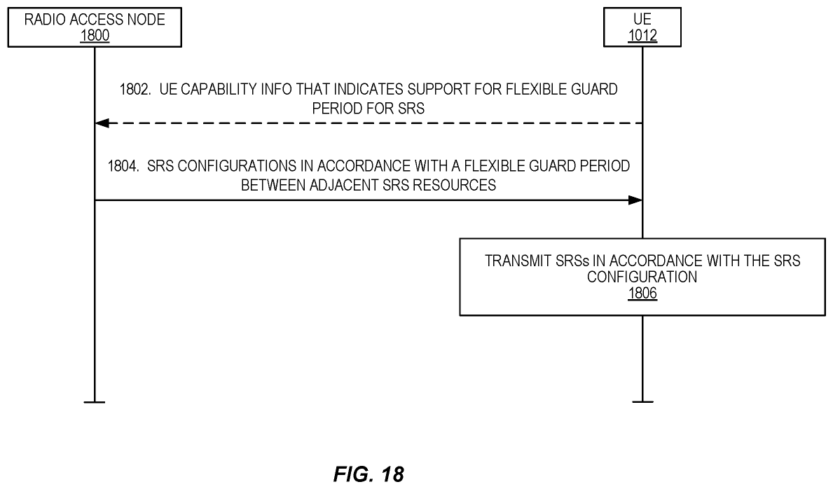

FIG. 18 illustrates the operation of a radio access node 1800 and a UE 1012 in accordance with at least some aspects of the embodiments described above. The radio access node 1800 may be a base station 1002 or a node that implements part of the functionality of the base station 1002 (e.g., a gNB-CU). Optional steps are represented by dashed lines/boxes. As illustrated, optionally the UE 1012 transmits, to the radio access node 1800, UE capability information (step 1802). As described above, the UE capability information includes information that indicates whether the UE 1012 supports flexible guard periods between SRS resources. For example, the UE capability information may indicate one or more guard period tables (e.g., from among two or more predefined or preconfigured tables) that are supported by the UE 1012.

The radio access node 1800 transmits or initiates transmission of an SRS configuration to the UE 1012 (step 1804). The SRS configuration includes a configuration of one or more SRS resource sets each including one or more SRS resources. The SRS configuration is such that the amount of time between adjacent SRS resources (in the same slot or same SRS resource set and/or in different SRS resource sets) is greater than or equal to a minimum guard period. In this embodiment, the minimum guard period is a function of whether repetitions are used for SRS transmission (e.g., the repetition factor used for SRS transmission on the associated SRS resources), number of SRS combs, SCS, and/or UE capabilities (e.g., the UE capabilities of step 1802), as described above.

The UE 1012 receives the SRS configuration and transmits SRSs in accordance with the SRS configuration (step 1806). Throughout the description above, the guard period is described as being measured in a number of OFDM symbols. However, the guard period may be measured in any suitable time-domain unit. Further, while the embodiments described here focus on the use of OFDM, the described embodiments can be used in wireless networks using other types of signal waveforms such as, for example, SC-FDMA.

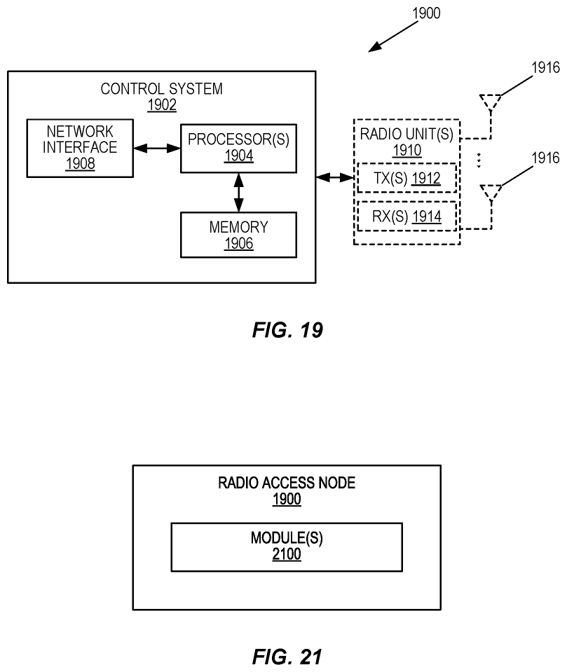

Further, while the description above primarily focuses on NR (and SRS), the embodiments described herein are equally applicable to other radio access types, e.g., LTE (for which it also holds, since LTE release 16, that SRS can be transmitted in any of the 14 symbols of a slot), and other types of reference signals are not precluded. FIG. 19 is a schematic block diagram of a radio access node 1900 according to some embodiments of the present disclosure. Optional features are represented by dashed boxes. The radio access node 1900 may be, for example, a base station 1002 or 1006 or a network node that implements all or part of the functionality of the base station 1002 or gNB described herein (e.g., all or part of the functionality of the radio access node 1200 of FIG. 12 or the radio access node 1800 FIG. 18, as described above). As illustrated, the radio access node 1900 includes a control system 1902 that includes one or more processors 1904 (e.g., Central Processing Units (CPUs), Application Specific Integrated Circuits (ASICs), Field Programmable Gate Arrays (FPGAs), and/or the like), memory 1906, and a network interface 1908. The one or more processors 1904 are also referred to herein as processing circuitry. In addition, the radio access node 1900 may include one or more radio units 1910 that each includes one or more transmitters 1912 and one or more receivers 1914 coupled to one or more antennas 1916. The radio units 1910 may be referred to or be part of radio interface circuitry. In some embodiments, the radio unit(s) 1910 is external to the control system 1902 and connected to the control system 1902 via, e.g., a wired connection (e.g., an optical cable). However, in some other embodiments, the radio unit(s) 1910 and potentially the antenna(s) 1916 are integrated together with the control system 1902. The one or more processors 1904 operate to provide one or more functions of a radio access node 1900 as described herein (e.g., all or part of the functionality of the radio access node 1200 of FIG. 12 or the radio access node 1800 of FIG. 18, as described above). In some embodiments, the function(s) are implemented in software that is stored, e.g., in the memory 1906 and executed by the one or more processors 1904.

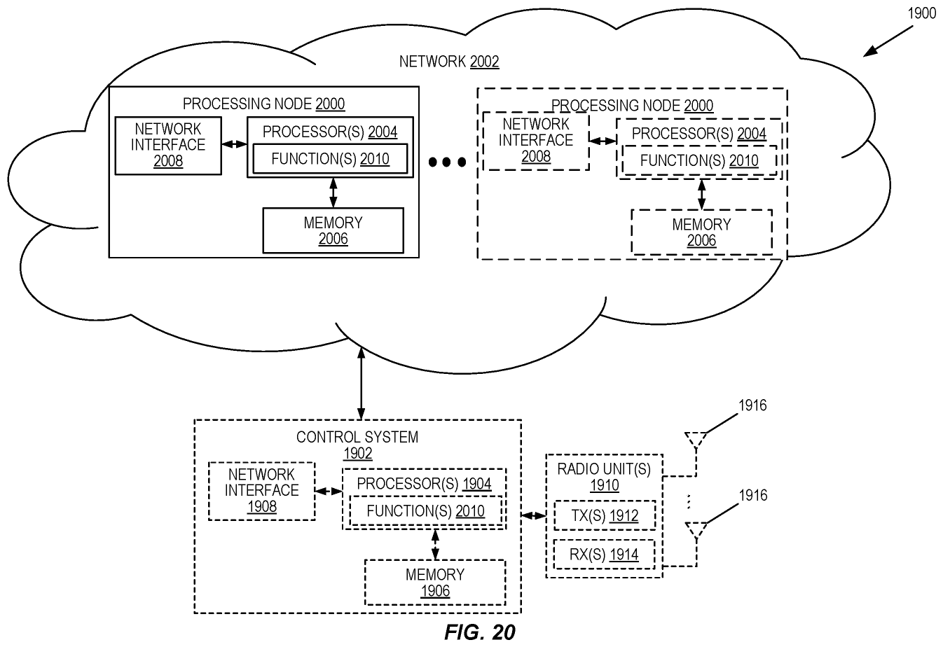

FIG. 20 is a schematic block diagram that illustrates a virtualized embodiment of the radio access node 1900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1900 in which at least a portion of the functionality of the radio access node 1900 is implemented as a virtual component(s) (e.g., via a virtual machine(s) executing on a physical processing node(s) in a network(s)). As illustrated, in this example, the radio access node 1900 may include the control system 1902 and/or the one or more radio units 1910, as described above. The control system 1902 may be connected to the radio unit(s) 1910 via, for example, an optical cable or the like. The radio access node 1900 includes one or more processing nodes 2000 coupled to or included as part of a network(s) 2002. If present, the control system 1902 or the radio unit(s) are connected to the processing node(s) 2000 via the network 2002. Each processing node 2000 includes one or more processors 2004 (e.g., CPUs, ASICs, FPGAs, and/or the like), memory 2006, and a network interface 2008.

In this example, functions 2010 of the radio access node 1900 described herein (e.g., all or part of the functionality of the radio access node 1200 of FIG. 12 or the radio access node 1800 of FIG. 18, as described above) are implemented at the one or more processing nodes 2000 or distributed across the one or more processing nodes 2000 and the control system 1902 and/or the radio unit(s) 1910 in any desired manner. In some particular embodiments, some or all of the functions 2010 of the radio access node 1900 described herein are implemented as virtual components executed by one or more virtual machines implemented in a virtual environment(s) hosted by the processing node(s) 2000. As will be appreciated by one of ordinary skill in the art, additional signaling or communication between the processing node(s) 2000 and the control system 1902 is used in order to carry out at least some of the desired functions 2010. Notably, in some embodiments, the control system 1902 may not be included, in which case the radio unit(s) 1910 communicate directly with the processing node(s) 2000 via an appropriate network interface(s).

In some embodiments, a computer program including instructions which, when executed by at least one processor, causes the at least one processor to carry out the functionality of radio access node 1900 or a node (e.g., a processing node 2000) implementing one or more of the functions 2010 of the radio access node 1900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 21 is a schematic block diagram of the radio access node 1900 according to some other embodiments of the present disclosure. The radio access node 1900 includes one or more modules 2100, each of which is implemented in software. The module(s) 2100 provide the functionality of the radio access node 1900 described herein (e.g., all or part of the functionality of the radio access node 1200 of FIG. 12 or the radio access node 1800 of FIG. 18, as described above). This discussion is equally applicable to the processing node 2000 of FIG. 20 where the modules 2100 may be implemented at one of the processing nodes 2000 or distributed across multiple processing nodes 2000 and/or distributed across the processing node(s) 2000 and the control system 1902.

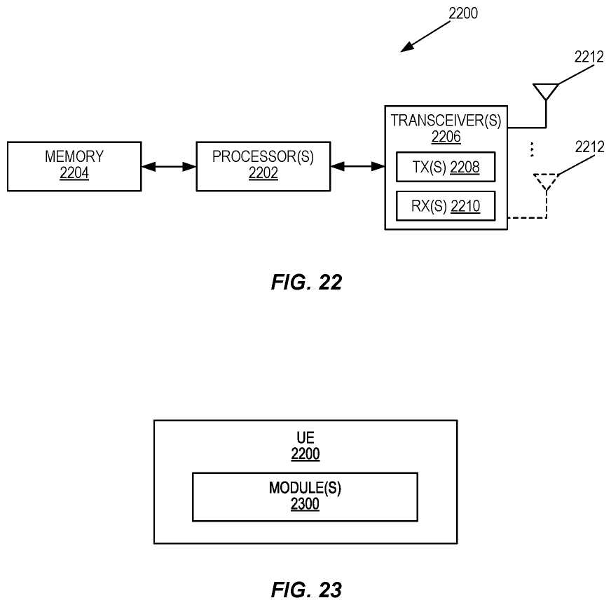

FIG. 22 is a schematic block diagram of a wireless communication device 2200 according to some embodiments of the present disclosure. As illustrated, the wireless communication device 2200 includes one or more processors 2202 (e.g., CPUs, ASICs, FPGAs, and/or the like), memory 2204, and one or more transceivers 2206 each including one or more transmitters 2208 and one or more receivers 2210 coupled to one or more antennas 2212. The transceiver(s) 2206 includes radio-front end circuitry connected to the antenna(s) 2212 that is configured to condition signals communicated between the antenna(s) 2212 and the processor(s) 2202, as will be appreciated by on of ordinary skill in the art. The processors 2202 are also referred to herein as processing circuitry. The transceivers 2206 are also referred to herein as radio circuitry. In some embodiments, the functionality of the wireless communication device 2200 described above (e.g., all or part of the functionality of the UE 1012 of FIG. 12 or FIG. 18, as described above) may be fully or partially implemented in software that is, e.g., stored in the memory 2204 and executed by the processor(s) 2202. Note that the wireless communication device 2200 may include additional components not illustrated in FIG. 22 such as, e.g., one or more user interface components (e.g., an input/output interface including a display, buttons, a touch screen, a microphone, a speaker(s), and/or the like and/or any other components for allowing input of information into the wireless communication device 2200 and/or allowing output of information from the wireless communication device 2200), a power supply (e.g., a battery and associated power circuitry), etc.

In some embodiments, a computer program including instructions which, when executed by at least one processor, causes the at least one processor to carry out the functionality of the wireless communication device 2200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 23 is a schematic block diagram of the wireless communication device 2200 according to some other embodiments of the present disclosure. The wireless communication device 2200 includes one or more modules 2300, each of which is implemented in software. The module(s) 2300 provide the functionality of the wireless communication device 2200 described herein (e.g., all or part of the functionality of the UE 1012 of FIG. 12 or FIG. 18, as described above).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a wireless communication device, the method comprising:
receiving a Sounding Reference Signal, SRS, configuration from a radio access node, wherein the SRS configuration defines SRS resources in compliance with a predefined or preconfigured minimum guard period between adjacent SRS resources in different slots; and
transmitting SRSs in accordance with the SRS configuration.

2. The method of claim 1 wherein the SRS configuration defines a first SRS resource set comprising one or more SRS resources in a first slot and a second SRS resource set comprising one or more resources in a second slot that immediately follows the first slot, and an amount of time between:
(a) a first SRS resource in the first SRS resource set, and
(b) a second SRS resource in the second SRS resource set that is adjacent to the first SRS resource in the first SRS resource set,
wherein the amount of time is greater than the predefined or preconfigured minimum guard period between adjacent SRS resources in different slots.

3. The method of claim 2 wherein the first SRS resource in the first SRS resource set is a last, in time, SRS resource from among the one or more SRS resources comprised in the first SRS resource set, and the second SRS resource in the second SRS resource set is a first, in time, SRS resource from among the one or more SRS resources comprised in the second SRS resource set.

4. The method of claim 2 wherein both the first SRS resource set and the second SRS resource set are configured for antenna switching.

5. The method of claim 1 wherein the predefined or preconfigured minimum guard period between adjacent SRS resources in different slots is defined in terms of a number of OFDM symbols.

6. The method of claim 1 wherein the predefined or preconfigured minimum guard period between adjacent SRS resources in different slots is a function of one or more parameters.

7. The method of claim 6 wherein the one or more parameters comprise a parameter that is indicative of whether repetitions are used for SRS transmission on at least one of the adjacent SRS resources.

8. The method of claim 6 wherein the one or more parameters comprise a repetition factor used for SRS transmission on at least one of the adjacent SRS resources.

9. The method of claim 6 wherein the one or more parameters comprise subcarrier spacing.

10. The method of claim 6 wherein the one or more parameters comprise a number of combs used for SRS transmission.

11. The method of claim 6 wherein the one or more parameters comprise a capability of the wireless communication device (40-12) to support flexible minimum guard periods for SRS.

12. The method of claim 6 wherein the one or more parameters comprise a repetition factor used for SRS transmission on at least one of the adjacent SRS resources and subcarrier spacing.

13. A wireless communication device comprising: one or more transmitters;
one or more receivers; and
processing circuitry associated with the one or more transmitters and the one or more receivers, the processing circuitry configured to cause the wireless communication device to:
receive a Sounding Reference Signal, SRS, configuration from a radio access node, wherein the SRS configuration defines SRS resources in compliance with a predefined or preconfigured minimum guard period between adjacent SRS resources in different slots; and
transmit SRSs in accordance with the SRS configuration.

14. (canceled)

15. A method performed by a wireless communication device, the method comprising:
receiving a Sounding Reference Signal, SRS, configuration from a radio access node, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) a number of combs used for SRS transmission, (d) subcarrier spacing, (e) capability of the wireless communication device to support flexible minimum guard periods for SRS, or (f) a combination of any two or more of (a)-(e); and
transmitting SRSs in accordance with the SRS configuration.

16. The method of claim 15 wherein the adjacent SRS resources are in a same slot.

17. The method of claim 15 wherein the adjacent SRS resources are in different slots.

18. The method of claim 15 wherein both of the adjacent SRS resources are configured for antenna switching.

19. The method of claim 15 further comprising transmitting, to the radio access node, an indication of whether the wireless communication device supports flexible minimum guard periods for SRS, wherein the guard period for the adjacent SRS resources is a function of the indication.

20. The method of claim 19 wherein the indication comprises an indication of one or more of a plurality of predefined or preconfigured tables that define the minimum guard period between adjacent SRS resources as a function of one or more parameters.

21. (canceled)

22. A wireless communication device comprising:
one or more transmitters;
one or more receivers; and
processing circuitry associated with the one or more transmitters and the one or more receivers, the processing circuitry configured to cause the wireless communication device to:
receive a Sounding Reference Signal, SRS, configuration from a radio access node, wherein the SRS configuration defines SRS resources in compliance with a minimum guard period between adjacent SRS resources that is a function of: (a) whether repetitions are used for SRS transmission on at least one of the adjacent SRS resources, (b) a repetition factor used for SRS transmission on at least one of the adjacent SRS resources, (c) a number of combs used for SRS transmission, (d) subcarrier spacing, (e) capability of the wireless communication device to support flexible minimum guard periods for SRS, or (f) a combination of any two or more of (a)-(e); and
transmit SRSs in accordance with the SRS configuration.

23-45. (canceled)
